(19) United States
(12) Patent Application Publication
(10) Pub. No.: US 2013/0110013 A1
(43) Pub. Date: May 2, 2013

(54) PORTABLE KNEE REHABILITATION DEVICE

(71) Applicants: David Lee Carlson, Canton, OH (US); Christopher Michael Perry, Akron, OH (US)

(72) Inventors: David Lee Carlson, Canton, OH (US); Christopher Michael Perry, Akron, OH (US)

(21) Appl. No.: 13/659,403

(22) Filed: Oct. 24, 2012

Related U.S. Application Data
(60) Provisional application No. 61/553,497, filed on Oct. 31, 2011.

(51) Int. Cl. A61H 1/02

(52) U.S. Cl. 601/5

(57) ABSTRACT

A device for rehabilitating a knee after knee surgery includes a support adapted to support the leg at the popliteal fossa while allowing the knee to be bent about the support with little interference from the support. A method of knee rehabilitation includes the step of supporting the patient's leg on the support and allowing the patient to control to movement in order to overcome muscle guarding. The support is carried by uprights that are spaced apart far enough to allow the patient to be positioned on his back between the uprights with the knee to be rehabilitated disposed over the support and the other leg stretched straight under the support.

### CROSS REFERENCE TO RELATED APPLICATIONS

This application claims the benefit of U.S. Provisional Patent Application 61/553,497 filed Oct. 31, 2011; the disclosures of which are incorporated herein by reference.

### BACKGROUND OF THE DISCLOSURE

1. Technical Field

The invention generally relates to devices and methods used with patients undergoing physical therapy and, more particularly, to devices and methods used for rehabilitating the patient's knee following knee replacement surgery. The device and method allows the patient to control the range and aggressiveness of the movement so that the patient is not expending energy fighting movement imposed by the physical therapist.

2. Background Information

Partial and total knee replacement surgery has become increasingly common to treat knee ailments such as severe arthritis. In knee replacement surgery, the damaged portions of the knee are replaced with metal or plastic components. The repaired knee typically has good strength and a good range of motion after the patient performs post-surgical physical therapy. The physical therapy may last six to eight weeks after the surgery and involve building strength and recovering a wide range of motion through movement of the knee and stretching. Shortly after surgery, physical therapy is difficult because the knee will not easily bend because of scar tissue, muscle atrophy, and muscle guarding. Muscle guarding is a protective response by the patient's muscle that results from pain or fear that movement will cause pain. Patients often resist the range of motion therapy at the beginning of the therapy because they fear the possibility of injuring the knee and the fear that bending the knee will be painful. Thus, a patient will often fight against a therapist who is trying to move the knee through a range of movement. The muscle guarding makes the therapy more difficult for the therapist and makes the recovery process longer for the patient.

Knee rehabilitation is often performed on a padded table with the patient lying on his back. As such, a knee rehabilitation device to be used in these situations must be stable and self supporting when used on such a surface while accommodating a comfortable position for the patient and the patient's other leg. In addition, the human leg is fairly heavy and contains strong muscles. A knee rehabilitation device also must be sturdy enough to support a wide range of human legs. The user of the device will also desire a portable device that is easy to store and carry from location to location.

### SUMMARY OF THE DISCLOSURE

In one configuration, the disclosure provides a device for use with rehabilitating a knee. The device includes a support adapted to support the leg at the popliteal fossa while allowing the knee to be bent about the support with little interference from the support. The method of using the device to rehabilitate the knee includes the step allowing the patient to control the range and aggressiveness of the knee movement so that the patient is not expending energy muscle guarding.

The support is carried by uprights that are spaced apart far enough to allow the patient to be positioned on his back between the uprights with the knee to be rehabilitated disposed over the support and the other leg stretched straight under the support.

In one configuration, the position of the support is adjustable with respect to the base of the device so that the patient's knee can be positioned at different heights and angles with respect to his hips to provide different levels of support and potential mobility.

The support may include a freely rotating sleeve that moves with the knee to minimize friction between the knee and the device while the knee is being moved.

The uprights of the device may be collapsed into a flat configuration so that the device may be transported from location to location.

The method provided by the disclosure includes the steps of positioning a person's leg upwardly while the person is lying on his back and then providing a support for the back of the knee (popliteal fossa) and allowing the person to bend the leg with the back of the knee supported such that the foot is moved down in an arc while the thigh is substantially stationary and vertical. The position of the support is adjusted over time to show progress to the person and encourage the use of the device and the further rehabilitation of the knee. The method also includes the step of rotating the support with the knee as the knee is bent and straightened.

### BRIEF DESCRIPTION OF THE DRAWINGS

FIG. 1 is a front elevation of the knee rehabilitation device.

FIG. 2 is a section view taken along line 2-2 of FIG. 1.

FIG. 3 is a top plan view of the device in the erected position.

FIG. 4 is a top plan view of the device in the collapsed position.

FIG. 5 is section view taken along line 5-5 of FIG. 3.

FIG. 6 is a section view taken along line 6-6 of FIG. 5.

Similar numbers refer to similar parts throughout the specification.

### DETAILED DESCRIPTION OF THE DISCLOSURE

A first exemplary configuration of the portable knee rehabilitation device is indicated generally by the reference numeral 10 in the accompanying drawings. Device 10 is used to help a patient rehabilitate his or her knee after knee replacement surgery. Device 10 helps support the knee while the patient stretches the knee to regain a desired range of knee motion. In practice, the patient or the physical therapist adjusts the device 10 to the desired position. The patient then lies on his or her back and lifts the leg over device 10 and rests the back of the knee on device 10 and gently bends the knee while the knee is supported from behind. Device 10 has the advantages that it provides stable but adjustable support for the knee in a manner that fits behind knee while allowing a natural range of motion. Device 10 is collapsible for portability.

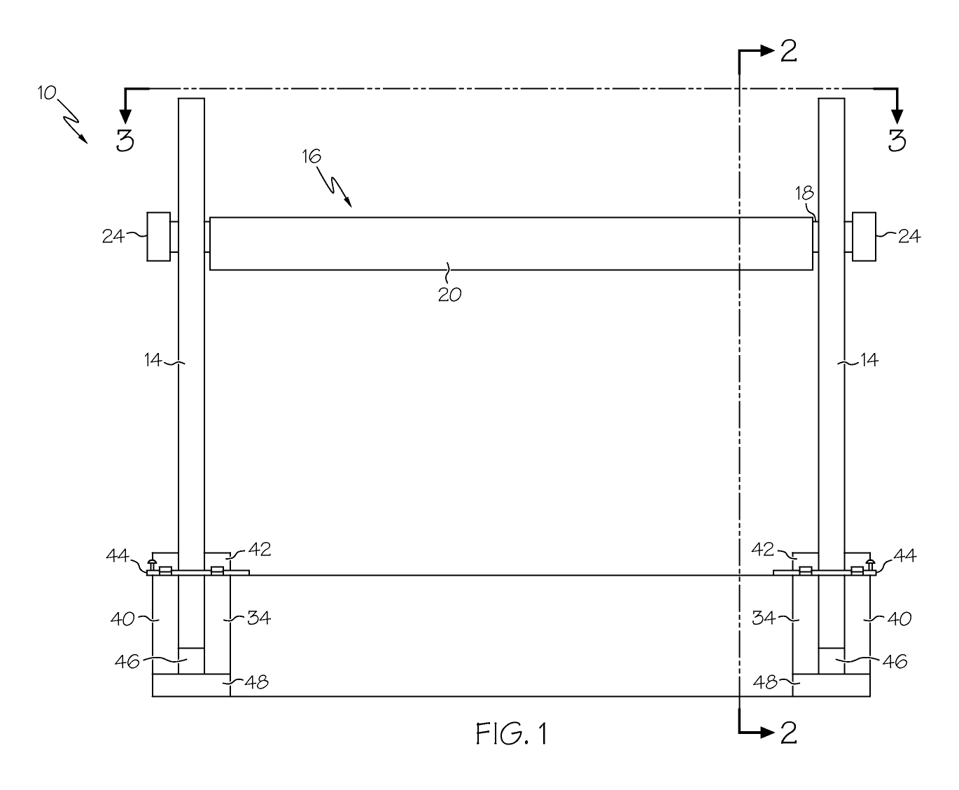

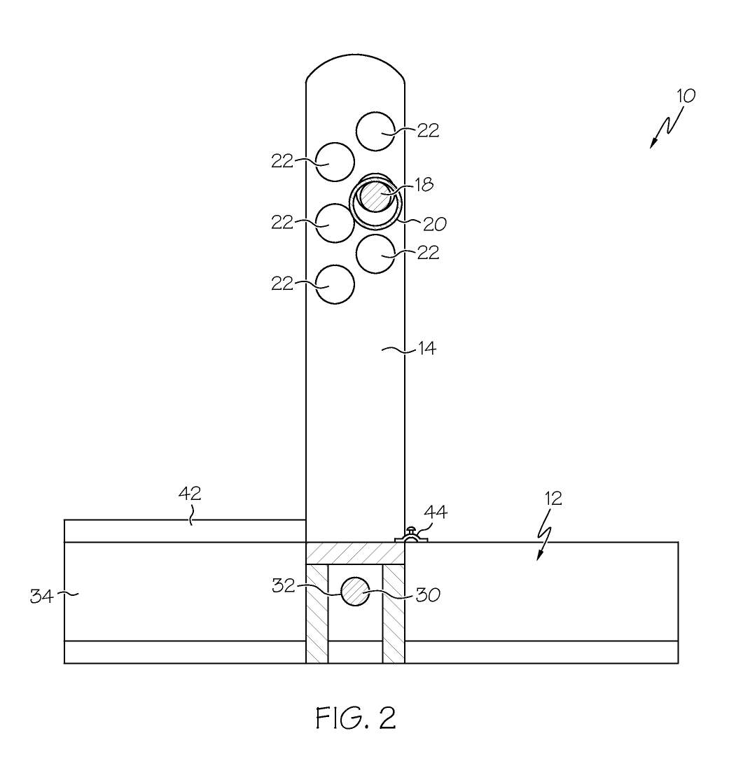

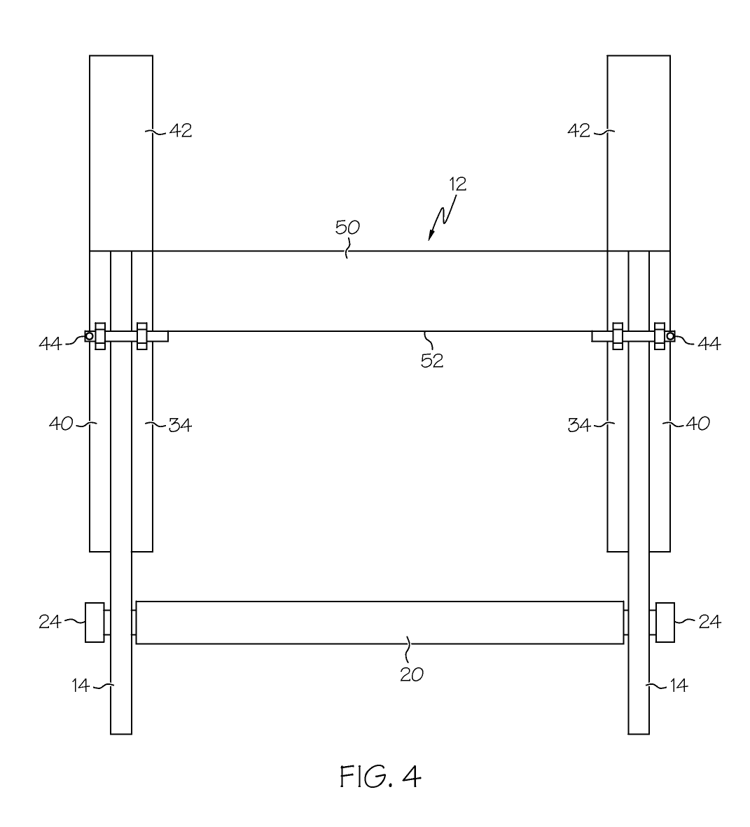

Device 10 generally includes a base structure 12 that carries a pair of uprights 14 that are selectively movable between erected and collapsed positions. The erected position is depicted in FIGS. 1-3 and the collapsed, portable configuration is depicted in FIG. 4. A support 16 extends between uprights 14. Support 16 is mounted to uprights 14 so that it will pivot with the user's knee. Support 16 includes an inner rod 18 and an outer padded sleeve 20 that is loosely carried on inner rod 18 between uprights 14. Inner rod may have a one inch outer diameter while sleeve 20 may have a thickness of one-quarter inch. Sleeve 20 may be fabricated from a resilient crushable foam material. The combined inner rod 18 and sleeve 20 are small enough to allow a good range of knee motion while they are fit behind the patient's knee. Support 16 is also large enough to provide the desired comfortable support while device 10 is in use.

The position of support 16 is adjustable with respect to base 12. In the exemplary configuration, each upright 14 defines a plurality of support openings 22 disposed at different heights and lateral locations so that support 16 may be positioned at different heights and lateral offsets from base 12 so that device 10 may be adjusted for use with different patients and to provide for varying levels of support with the same patient. In the exemplary configuration, each upright 14 defines six support openings 22 so that six different positions for support 16 are available to the user. Each support openings 22 is fully surrounded by the material of an upright 14 so that support 16 cannot be slid laterally out of openings 22 while in use. End caps 24 are used to prevent support 16 from being removed axially while in use. When the user wishes to adjust the position of support 16, the user removes one of end caps 24 and slides inner rod 18 out of uprights 14 and sleeve 20. The user then slides inner rod 18 back through the desired opening 22 in one upright while holding sleeve 20 aligned with the opening 22 so that inner rod 18 slides directly into sleeve 20. The user continues to slide inner rod 18 through the corresponding opening in the opposite upright. End cap 24 is then reattached and device 10 is ready to use.

The lowest position of support 16 is used to allow the greatest range of motion while the highest position is used at the beginning of the rehabilitation process for the least range of motion. Showing the patient that support 16 has been moved from one position to another during the course of the rehabilitation provide positive feedback to the patient and encourages continued rehabilitation efforts.

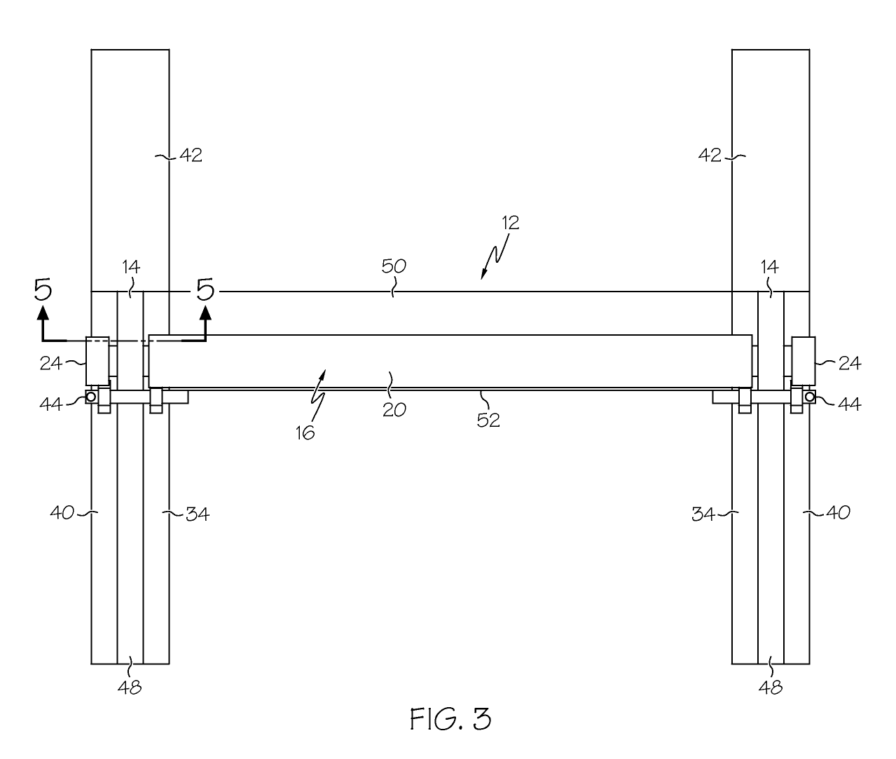

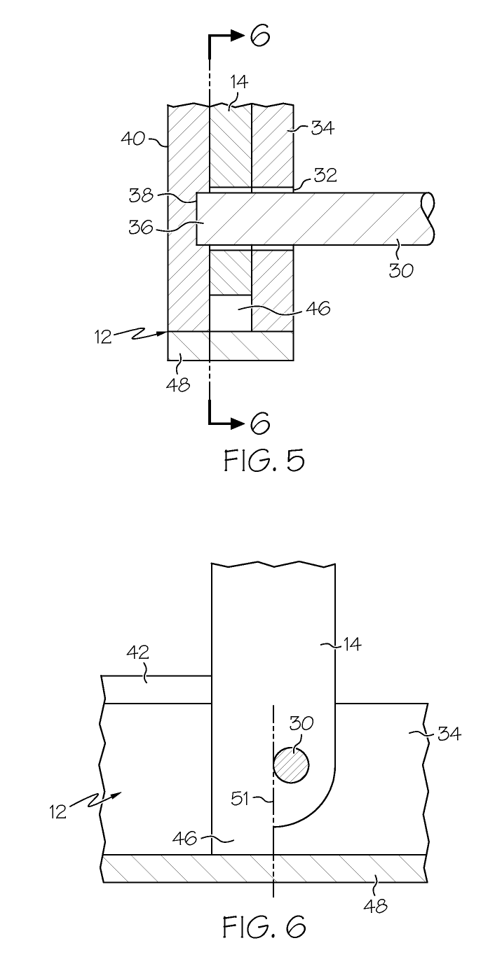

Uprights 14 are carried by a pivot rod 30 that is housed within base 12. Rod 30 passes through openings 32 defined by the inner lateral walls 34 of base 12. In some configurations, the ends 36 of pivot rod 30 may be received in cups 38 defined by the inner surfaces of outer lateral support walls 40 as shown in FIG. 5. Uprights 14 may rotate about rod 30 or with rod 30. Uprights 14 may thus be rotated from the erected position of FIG. 3 to the collapsed position of FIG. 4 by rotating uprights 14 and support 16 about the rotational axis of pivot rod 30. Walls 34 and 40 are long enough to support device 10 against tipping in both the forward and rearward directions. Walls 34 and 40 extend forward and rearward from uprights a distance of at least half the height of uprights 14 to provide stability.

The erected position of device 10 is maintained through the engagement of uprights 14 with a rear support 42 that is carried on top of lateral walls 34 and 40. The forward end of rear support 42 is positioned to abut the rear surface of its corresponding upright 14 when upright 14 is disposed vertical with respect to the lower surface of base 12. A front support 44 is openable and closable and is used to selectively engage the front surface of its corresponding upright 14. In the exemplary configuration, each front support 44 is a sliding deadbolt-type lock member that may be manually slid between its opened and closed position. In the closed position, support 44 traps upright 14 between supports 42 and 44 so that upright 14 is stable. In addition to these supports, upright 14 may be configured to engage the upper surface of a lower wall 48 disposed under upright 14. In this configuration, each upright 14 defines a foot 46 (FIG. 6) that rotates to abut the upper surface of lower support 48 when upright 14 is vertical. As shown in FIG. 6, the pivot axis of rod 30 is offset in a forward direction from foot 46 and the front of foot 46 is aligned with the rear of pivot rod 30 as indicated by reference numeral 51.

In order to collapse device 10 to make it portable, the user moves front supports 44 to their open positions. Uprights 14 may then be moved down to their collapsed positions as shown in FIG. 4. Supports 44 may then be closed over the rear surfaces of uprights 14 to lock device 10 in the collapsed position. In addition to supports 44, foot 46 may be configured to engage the inner surface of rear support 42 so that device 10 does not rattle when in the collapsed condition.

Base 12 also includes center cross support 50 that encloses pivot rod 30 and provides stability to device 10. Center cross support 50 is positioned under support 16 and is used to align the patient with support 16 when device 10 is used. Support 50 defines a front surface 52 that is positioned to be engaged by the buttock of the patient when device 10 is in use. In this position, the patient's thigh is substantially vertical with support 16 disposed behind the knee. The other leg of the patient may be disposed over top of support 50 and under support 16.

In the foregoing description, certain terms have been used for brevity, clearness, and understanding. No unnecessary limitations are to be implied therefrom beyond the requirement of the prior art because such terms are used for descriptive purposes and are intended to be broadly construed. Moreover, the description and illustration of the invention is an example and the invention is not limited to the exact details shown or described. Throughout the description and claims of this specification the words “comprise” and “include” as well as variations of those words, such as “comprises,” “includes,” “comprising,” and “including” are not intended to exclude additives, components, integers, or steps.

1. A physical therapy device for use with rehabilitating the human knee after knee replacement surgery; the device comprising:
a base;
a pair of spaced uprights extending from the base; and
a knee support extending between and carried by the pair of uprights; the knee support being adapted to fit behind the knee that is being rehabilitated.

2. The device of claim 1, wherein the uprights are movable between erected and collapsed positions.

3. The device of claim 2, wherein the base includes a front support and a rear support for each of the uprights; a portion of the upright being sandwiched between the front support and the rear support when the upright is in the erected position.

4. The device of claim 3, wherein each of the front supports is movable between open and closed positions; the open position of the front support allowing the upright to move between its erected and collapsed positions.

5. The device of claim 3, wherein each upright includes a foot that engages the rear support when the upright is in the collapsed position.

6. The device of claim 5, wherein the base includes a lower support for each upright; the foot engaging the lower support when the upright is in the erected position.

7. The device of claim 6, wherein the base is horizontal and the uprights are disposed vertical in the erected position and the uprights are horizontal when the uprights are in the collapsed position.

8. The device of claim 7, wherein each of the uprights are mounted on a common pivot rod housed within the base; each foot including a front surface, a rear surface, and an end surface; the rear surface of the foot engaging the rear support when the upright is in the collapsed position; the end surface of the foot engaging the lower support when the upright is in the erected position; and the common pivot being offset from the front surface of the foot such that front surface of the foot is intermediate a center of the common pivot and the rear surface of the foot.

9. The device of claim 8, wherein the front surface of the foot is aligned with a rear of the common pivot rod.

10. The device of claim 1, wherein the knee support includes an inner rod and an outer padded sleeve that is loosely carried on the inner rod between the pair of uprights.

11. The device of claim 10, wherein the inner rod has a diameter of one inch and the sleeve has a thickness of one-quarter inch.

12. The device of claim 10, wherein the sleeve is fabricated from a resilient crushable foam material.

13. The device of claim 1, wherein the knee support is rotatable about its own axis with respect to the pair of uprights.

14. The device of claim 13, wherein the knee support includes an inner support and an outer sleeve that is movable with respect to the inner support.

15. The device of claim 1, wherein the position of the support is adjustable to change the distance between the support and the base.

16. The device of claim 15, wherein each upright defines a plurality of support openings disposed at different heights and lateral locations so that support may be positioned at different heights and lateral offsets with respect to base.

17. The device of claim 1, wherein the base includes a center cross support generally extending between the uprights and disposed below the knee support; the center cross support defining a front surface adapted to locate the person using the device with respect to the knee support.

18. A method of rehabilitating the human knee after knee replacement surgery; the method comprising:
positioning a person on his back with the leg having had the knee replacement surgery disposed substantially vertical with respect to a device having a knee support disposed between a pair of uprights;
moving the leg until the back of the knee engages the knee support; and
allowing the person to bend the knee with the assistance of gravity about the knee support to overcome muscle guarding.

19. The method of claim 18, further comprising the step of adjusting the position of the knee support with respect to the uprights in order to show progress to the person.

20. The method of claim 18, further comprising the step of collapsing the uprights with respect to a base to make the device more compact for travel.
